(19) United States
(12) Patent Application Publication
(10) Pub. No.: US 2026/0339094 A1
(43) Pub. Date: Oct. 29, 2026

(54) Endoscope Device, Correction Pair Arrangement, Endoscope and Imaging System

(71) Applicant: KARL STORZ SE & Co. KG, Tuttlingen (DE)

(72) Inventors: Robin Hegenbarth, Tuttlingen (DE); Sebastian Barth, Tuttlingen (DE)

(73) Assignee: KARL STORZ SE & Co. KG, Tuttlingen (DE)

(21) Appl. No.: 19/107,792

(22) PCT Filed: Aug. 29, 2023
(86) PCT No.: PCT/EP2023/073638

§ 371 Date: Feb. 28, 2025

(30) Foreign Application Priority Data
Aug. 31, 2022 (KR) 10-2022-0110314

(51) Int. Cl. G02B 23/24

(52) U.S. Cl. CPC G02B 23/243; G02B 23/2461; G02B 23/2484

(57) ABSTRACT

The invention relates to an endoscope device (110) comprising a lens arrangement (112) which is configured to image light both in the visible range and in the near infrared range and is symmetrical with respect to a first plane of symmetry (120) perpendicular to the optical axis (114). The lens arrangement (112) comprises six rod lenses (122) and two correction elements (124), which each comprise a lens system (128) having a first lens (130) and a second lens (132). The first lens (130) is manufactured from a first glass and the second lens (132) is manufactured from a second glass. The first glass and the second glass have different Abbe numbers, with relative partial dispersions of the first glass and the second glass deviating from glass with normal dispersion in the opposite sense. The lens arrangement (112) also comprises a correction pair arrangement (134) which comprises two of the correction elements (124) symmetrical with respect to one another in relation to a second plane of symmetry (136) perpendicular to the optical axis (114).

The invention relates to an endoscope device, in particular for hyperspectral and/or multispectral imaging, a correction pair arrangement for a lens arrangement of an endoscope, an endoscope and an imaging system having an endoscope.

The prior art has disclosed lens arrangements for endoscopes that comprise a plurality of rod lenses. Such lens arrangements are combined with an objective and an eyepiece. Light from an observed object incident at the objective can be transmitted to the eyepiece through the lens arrangement. In this way, the observed object may be imaged in a manner known per se.

In the field of endoscopy, use is increasingly made of endoscopic devices that create multispectral or hyperspectral images. In addition to two spatial dimensions, like those in a conventional camera image for example, multispectral or hyperspectral images have a spectral dimension. The spectral dimension comprises a plurality of spectral bands (wavelength bands). Multispectral and hyperspectral images substantially differ in terms of the number and the width of their spectral bands. In principle, such systems may also be suitable for performing fluorescence recordings.

Several imaging devices for creating such multispectral or hyperspectral images are known, especially in the context of medical applications. For example, DE 20 2014 010 558 U1 describes a device for recording a hyperspectral image of an examination region of a body. An entrance objective for creating an image in an image plane and a slot-shaped stop in the image plane for masking a slot-shaped region of the image are arranged in the device. The light that passes through the stop is fanned open by means of a dispersive element and recorded by means of a camera sensor. As a result, a multiplicity of spectra, each with an assigned spatial coordinate along the longitudinal direction of the slot-shaped stop, can be recorded by the camera sensor. In a direction that differs from the longitudinal direction of the slot-shaped stop, the described device is furthermore configured to record further spectra along the longitudinal direction of the slot-shaped stop. The method for creating multispectral or hyperspectral images on which this disclosure is based is also known as a so-called pushbroom method.

In addition to the pushbroom method, there are further methods for creating multispectral or hyperspectral images. In what is known as the whiskbroom method, the examination region or else object is traversed point-by-point, and a spectrum is obtained for each point. In contrast thereto, a plurality of images with the same spatial coordinates are recorded in the staring method. In this case, different spectral filters and/or illumination sources are used from image to image in order to resolve spectral information. Furthermore, there are methods according to which a two-dimensional multi-color image is decomposed by way of suitable optical elements such as optical slicers, lenses and prisms into a plurality of individual spectral images, which are captured simultaneously on different detectors or detector regions. This is sometimes referred to as the snapshot approach.

As described in DE 10 2020 105 458 A1, multispectral and hyperspectral imaging devices are particularly suitable as endoscopic imaging devices. In that context, multispectral and/or hyperspectral imaging is a fundamental application, for example for diagnostics and for assessing a success or a quality of a procedure.

Multimodal endoscope devices allow selective recording of white-light images and/or multispectral images and/or fluorescence images and/or hyperspectral images.

For the aforementioned applications, it is advantageous or even mandatory to be able to transmit and image light both in the visible range and in the near infrared range. For example, multispectral or hyperspectral imaging can be used in particularly versatile fashion if it is possible to work in a spectral range between approximately 450 nm and 1000 nm. For fluorescence imaging, too, it is advantageous if a broad spectral range is available because in that case the same optical system can be used to record fluorescence images and white-light images. The latter frequently provide more comprehensive information about the anatomy observed, and so it is appropriate to combine these with fluorescence images. In this respect, existing lens arrangements supply an imaging quality that frequently is not satisfactory over a broad spectral range. In that case, it is regularly necessary to work with a reduced resolution or a deficient focus setting in parts of the spectral range used overall.

Moreover, the user will regularly consider it unsatisfactory to work with a focus setting optimized for the near infrared range if this is accompanied by defocusing in the visible range as the image quality is then subjectively perceived as insufficient.

In practice, it is not practical in many situations for the user to readjust a focus of the utilized endoscope device depending on the respective observation mode. If overlaid representations are intended to be created, for example by virtue of white-light images and fluorescence images or white-light images and hyperspectral images/multispectral images being overlaid on one another, there is a switchover, optionally in automated fashion and at very short time intervals. Fluorescence imaging and multispectral imaging may be performed in real time. Hyperspectral imaging is regularly implemented at least substantially in real time; for example, a hyperspectral image data record takes a few seconds to record. However, all wavelengths are considered in a single image recording in the process, which is why a wavelength-dependent readjustment of the focus is not practical.

Using the prior art as a starting point, the invention addresses the problem of enabling endoscopic imaging with high quality over a broad spectral range.

According to the invention, this problem is solved by an endoscope device, a correction pair arrangement for a lens arrangement of an endoscope, an endoscope and an imaging system, as described herein and defined in the claims.

An endoscope device, in particular for hyperspectral and/or multispectral imaging, comprises a lens arrangement that defines an optical axis and that is configured to optically couple an eyepiece to an objective. The lens arrangement is configured for at least substantially equivalent transmission and/or imaging of light for a given focus setting in particular, both in the visible range and in the near infrared range and specifically both over a majority of the visible range and in the near infrared range. The lens arrangement is symmetrical with respect to a first plane of symmetry that is perpendicular to the optical axis.

The lens arrangement comprises at least six rod lenses and at least two correction elements that together with the rod lenses define an optical system and that each comprise a lens system having at least a first lens and a second lens. The first lens is manufactured from a first glass and the second lens is manufactured from a second glass. The first glass and the second glass have different Abbe numbers. A relative partial dispersion of the first glass and a relative partial dispersion of the second glass deviate in the opposite sense from glass with normal dispersion. Moreover, the lens arrangement comprises at least one correction pair arrangement comprising two of the correction elements that are symmetrical to one another in relation to a second plane of symmetry that is perpendicular to the optical axis.

The invention also relates to a correction pair arrangement for a lens arrangement of an endoscope, comprising at least two correction elements that define an optical axis and are configured together with the plurality of rod lenses to define an optical system and each comprise a lens system having at least a first lens and a second lens. The first lens is manufactured from a first glass and the second lens is manufactured from a second glass. The first glass and the second glass have different Abbe numbers. A relative partial dispersion of the first glass and a relative partial dispersion of the second glass deviate in the opposite sense from glass with normal dispersion. The correction elements are symmetrical to one another with respect to a plane of symmetry that is perpendicular to the optical axis.

The features according to the invention allow high-quality endoscopic imaging over a broad spectral range. The inventors have recognized that in order to obtain a high imaging quality over a broad spectral range, lens errors need to be addressed in a very targeted manner and optical components need to be suitably selected and combined to this end. The use of paired correction elements and the use of suitable symmetry in the structure of the lens arrangement advantageously allows a chromatic aberration to be reduced to such an extent that images with a high imaging quality may be recorded both in the visible range and in the near infrared range without the focus needing to be readjusted/set in a wavelength-dependent fashion. Moreover, the inventors have recognized that for high-quality multispectral or hyperspectral imaging in particular, light intensities that are as high as possible should be available on appropriate detection sensor systems, where possible over the entire imaged spectral range. Moreover, the use of rod lenses and additional correction elements allows the use of conventional assembly methods for the manufacture of endoscopes or endoscope shafts, in which endoscope devices or lens arrangements according to the invention are used. It is possible to use known method steps for constructing the lens system, only the combined optical components differ from previous lens arrangements.

The objective may comprise a lens system that is configured to allow light to be input coupled and to transmit input-coupled light to the lens arrangement. For example, the input-coupled light is light that was diffusely reflected and/or emitted by an object to be observed. In particular, this may be diffusely reflected illumination light and/or fluorescence.

In some embodiments, the eyepiece is configured to supply light transmitted by the lens arrangement to an image capture sensor system. The image capture sensor system may be a constituent part of an imaging unit, in particular of a multimodal imaging unit, by means of which multispectral imaging, hyperspectral imaging, white-light imaging and/or fluorescence imaging is performable, preferably on an alternative basis.

The endoscope device may be a constituent part of an endoscope, in particular of a medical endoscope. In general, this may be a medical endoscope device. In addition to the endoscope device, the endoscope may comprise the eyepiece and/or the objective. In an alternative to that or in addition, the eyepiece and/or the objective may be part of the endoscope device.

Multispectral imaging may relate in particular to imaging in which at least two, in particular at least three and in some cases at least five spectral bands can be or are captured independently of one another. The individual spectral bands for multispectral imaging may be defined by suitable and optionally switchable optical filters. Hyperspectral imaging may relate in particular to imaging in which at least 20, at least 50 or even at least 100 spectral bands can be or are captured independently of one another. For example, hyperspectral imaging may be performable according to the pushbroom method and/or according to the whiskbroom method and/or according to the staring method and/or according to a snapshot principle.

In particular, the rod lenses may be arranged such that their longitudinal axes are arranged parallel to one another and/or parallel to the optical axis of the lens arrangement. By preference, the longitudinal axes of the rod lenses and the optical axis coincide. The rod lenses and the correction elements may be arranged such that light that is transmitted and/or imaged by the lens arrangement passes through all rod lenses and all correction elements.

In some embodiments, the lens arrangement may have a length of at least 20 cm, at least 30 cm or even at least 40 cm. The lens arrangement may be rigid. Expressed differently, components of the lens arrangement, for example the at least six rod lenses and the at least two correction elements, in particular all components of the lens arrangement, may be unmovable relative to one another.

The endoscope device may also comprise the eyepiece and/or the objective. The eyepiece and/or the object may together with the lens arrangement form an imaging optical system.

The endoscope device may comprise a shaft in which the lens arrangement is received and/or fastened. In this case, the optical axis may be arranged parallel to a longitudinal axis of the shaft and in particular coincide with the latter. In other words, the shaft, the rod lenses and the correction elements in particular may be arranged coaxially.

In particular, “a majority of a wavelength range” means a wavelength range, preferably a continuous wavelength range, that covers at least 60%, preferably at least 70%, particularly preferably at least 80% and by preference at least 90%, of the reference wavelength range. In this context, the range from 400 nm to 750 nm should be understood to be the visible wavelength range. In this context, the term “near infrared range” relates in particular to wavelengths located outside of the visible wavelength range. Specifically, for a given focus setting, the lens arrangement may be configured for at least substantially equivalent transmission and imaging of light, both over the majority of the visible range and over a majority of at least the range from 800 nm to 1000 nm. Expressed differently, for a given focus setting, the lens arrangement may be configured for at least substantially equivalent transmission and imaging of light over a majority of the range from 480 nm to 900 nm and by preference over a majority of the range from 400 nm to 1000 nm.

In particular, “at least substantially equivalent transmission of light” should be understood to mean that a mean transmission in the specified wavelength range differs by no more than 30%, preferably by no more than 20%, particularly preferably by no more than 15% and by preference by no more than 10%, between the intervals for all pairs of intervals, selectable as desired in the aforementioned wavelength range, with a width of no more than 100 nm, no more than 50 nm or even no more than 10 nm. “At least substantially equivalent transmission of light” may comprise that a transmission in the specified wavelength range differs by no more than 30%, preferably by no more than 20%, particularly preferably by no more than 15% and by preference by no more than 10%, between the wavelengths for all pairs of wavelengths selectable as desired in the aforementioned wavelength range. In this context, “transmission” means transmittance in particular, i.e. a quotient of transmitted and incident intensity. In particular, the statements relate to those light intensities for which the transmission exhibits no intensity dependence or at least substantially no intensity dependence.

In particular, “at least substantially equivalent transmission and imaging of light” refers to the fact that the lens arrangement is usable both over a majority of the visible range and in the near infrared range. In other words, for a given focus setting, the lens arrangement is usable, in particular equivalently usable, both in the visible range and in the near infrared range.

Specifically, “substantially equivalent transmission of light” may be understood to mean that a mean transmission in the specified wavelength range differs by no more than 30%, preferably by no more than 20%, particularly preferably by no more than 15% and by preference by no more than 10%, between the intervals for all pairs of intervals, selectable as desired in the aforementioned wavelength range, with a width of no more than 100 nm, no more than 50 nm or even no more than 10 nm, in which the mean transmission in particular is less than 95%, less than 90% or less than 85%. “At least substantially equivalent transmission of light” may comprise that a transmission in the specified wavelength range differs by no more than 40%, preferably by no more than 30%, particularly preferably by no more than 20% and by preference by no more than 10%, between the wavelengths for all pairs of wavelengths selectable as desired in the aforementioned wavelength range, at which the transmission in particular is less than 95%, less than 90% or less than 85%. Additionally, the term may contain the case that there exists at least a portion of the aforementioned wavelength range in which the transmission is greater than 80%, greater than 85% or even greater than 90%. In this context, “transmission” means transmittance in particular, i. e. a quotient of transmitted and incident intensity. In particular, the statements relate to those light intensities for which the transmission exhibits no intensity dependence or at least substantially no intensity dependence. In other words, transmission of light with sufficient efficiency is possible over the entire aforementioned wavelength range.

Specifically, “substantially equivalent imaging of light” may be understood to mean that in the specified wavelength range and for all pairs of intervals, selectable as desired in the aforementioned wavelength range, with a width of no more than 100 nm, no more than 50 nm or even no more than 10 nm and in which in particular a mean RMS spot radius (“RMS” denotes “root mean square”) is above the diffraction limit, a mean RMS spot radius between the intervals differs by no more than a factor of 15, preferably by no more than a factor of 10, particularly preferably by no more than a factor of 5 and by preference by no more than a factor of 3. “Substantially equivalent imaging of light” may comprise that an RMS spot radius for all pairs of wavelengths, selectable as desired in the aforementioned wavelength range, at which the RMS spot radius is above the diffraction limit in particular differs between the wavelengths by no more than a factor of 15, preferably by no more than a factor of 10, particularly preferably by no more than a factor of 5 and by preference by no more than a factor of 3. Additionally, the term may contain the case that there exists at least a portion of the aforementioned wavelength range in which the RMS spot radius is below the diffraction limit. In other words, imaging of light with sufficiently good focusing is possible over the entire aforementioned wavelength range.

The term “for a given focus setting” means in particular that an incidence of the light into the lens arrangement remains unchanged, i.e. is implemented in the same way for different wavelengths. For example, if the lens arrangement is combined with an objective and/or an eyepiece and focused, the focus setting for the assessment of the transmission and imaging of light does not change at different wavelengths. The focus setting may comprise a predetermined and/or predeterminable focus setting for a specific wavelength in the aforementioned wavelength range, which is then maintained unchanged over the entire aforementioned range.

The rod lenses and/or the correction elements may take the form of at least substantially cylindrical, preferably circular cylindrical objects. A lateral face of the rod lenses and/or of the correction elements may be in the shape of a lateral cylinder face. Front and/or back surfaces of the rod lenses and/or of the correction elements may deviate from the shape of a cylinder and for example be convexly or concavely curved.

By preference, the rod lenses are elongate. For example, the rod lenses may have a length that is greater than a diameter of the rod lenses by at least a factor of 2, a factor of 3, a factor of 4, a factor of 5 or even a factor of 6. The rod lenses may take different or identical forms. The lens arrangement may comprise a plurality of different rod lens types in some embodiments. These may differ in respect of their dimension, their curvature, their refractive behavior, their coating, their material and/or other parameters.

Within the scope of this disclosure, the term “glass” may refer to any glass material. In this respect, “glass” should not be restricted to silicate glass or silicon-based glass, even though the first glass and/or the second glass may be silicate glass or silicon-based glass in some embodiments.

Within the scope of this disclosure, the Abbe number may be defined as follows:

ν_{d}=(n_{d}−1)/(n_{F}−n_{C}),

where n_{d}, n_{F} and n_{C} are the refractive indices of the relevant material at the corresponding Fraunhofer lines. For example, the corresponding wavelengths for the Fraunhofer lines d, F and C are 587.56 nm, 486.13 nm and 656.27 nm.

Alternatively, the Abbe number may also be defined as follows within the scope of this disclosure:

νₑ=(nₑ−1)/(n_{F′}−n_{C′}),

where nₑ, n_{F′} and n_{C′} are the refractive indices of the relevant material at the corresponding Fraunhofer lines. For example, the corresponding wavelengths for the Fraunhofer lines e, F′ and C′ are 546.07 nm, 479.99 nm and 643.85 nm.

In general, the aforementioned relative partial dispersion may relate to the relative partial dispersion for two wavelengths x, y and may be defined as follows:

P_{x,y}=(nₓ−n_{y})/(n_{F}−n_{C}),

where nₓ and n_{y} denote the refractive indices at the wavelengths x and y. Specifically, the aforementioned relative partial dispersion of the first glass and of the second glass may be P_{g,F}, where g and F denote the corresponding Fraunhofer lines. For example, the corresponding wavelengths for the Fraunhofer lines g and F and C′ are 435.83 nm and 486.13 nm.

In particular, a glass with normal dispersion should be understood to mean a glass for which the relevant relative partial dispersion and the Abbe number have a linear relationship, i.e. specifically a glass that is located on a straight line in a ν_{d}-P_{x,y} diagram that abides by the following relationship:

P_{x,y}=a_{x,y}+b_{x,y}·ν_{d},

where a_{x,y} and b_{x,y} are dimensionless constants that belong to the partial dispersion defined by x and y. This may also be formulated analogously for νₑ. For P_{g,F}, these constants are known to be a_{g,F}=0.6438 and b_{g,F}=0.001682. Such a glass is regularly also referred to as “normal glass”. It is distinguished by light being dispersed in the same way, independently of the spectral range.

Deviating from this, glass that deviates from glass with normal dispersion may exhibit different dispersion behaviors in different spectral ranges, for example be dispersive to a greater or lesser extent in the short wavelength range when compared to the long wavelength range. Such glass is sometimes also referred to as glass with abnormal dispersion.

It should be understood that these terms should not be equated to the occasionally used terms of normal dispersion and anomalous dispersion, which relate to the basic dispersion behavior of a material, specifically that of having a refractive index that increases with frequency (“normal dispersion”) or decreases with frequency (“anomalous dispersion”) . Rather, the glass properties described herein optionally relate to different derivatives of the dispersion at different wavelengths, even though these may have the same sign.

In particular, the relative partial dispersions of the first glass and of the second glass deviate in the opposite sense from glass with normal dispersion, to the effect that the first glass is on one side of the line in the ν_{d}-P_{x,y} diagram for glass with normal dispersion, and the second glass is on a second side opposite the first side. This may apply analogously to a ν_{de}-P_{x,y} diagram. A deviation parameter ΔP_{x,y} may be defined as follows:

ΔP_{x,y}=(nₓ−n_{y})/(n_{F}−n_{C})−a_{x,y}+b_{x,y}·ν_{d}.

This may also be formulated analogously for νₑ. A sign of the value of the deviation parameter ΔP_{x,y} may be different for the first glass and the second glass.

At least a majority and/or all of the first lens may consist of the first glass. At least a majority and/or all of the second lens may consist of the second glass. “At least a majority” may mean at least 55%, by preference at least 65%, preferably at least 75%, particularly preferably at least 85% and very particularly preferably at least 95%, to be precise in relation to a volume and/or a mass of an object in particular.

By preference, the first lens and the second lens are arranged immediately in succession and in particular in contact with one another, and/or they are formed integrally with one another, for example optically bonded and/or adhesively bonded to one another.

The correction elements in the correction pair arrangement may be arranged symmetrically to one another in relation to the second plane of symmetry. The correction elements in the correction pair arrangement may take an identical form and for example only be rotated relative to one another in order to establish symmetry. In other embodiments, the correction elements may be formed differently but symmetrically to one another.

In particular, a simple optical structure may be obtained if the first plane of symmetry and the second plane of symmetry are identical. In this way, optical modeling for adapting the lens arrangement can be performed particularly easily. In other embodiments, the first plane of symmetry and the second plane of symmetry may be spaced apart from one another along the optical axis.

In some embodiments, the lens arrangement comprises at least one further correction pair arrangement, wherein the further correction pair arrangement comprises two further ones of the correction elements that are symmetrical to one another in relation to a third plane of symmetry that is perpendicular to the optical axis. A high degree of imaging quality and imaging stability can be obtained as a result. The further correction pair arrangement may take an identical form to the correction pair arrangement. Alternatively, the correction pair arrangements may differ, for example in view of correction elements used and/or the relative position and/orientation thereof.

A high degree of flexibility in respect of the configuration of the lens arrangement and various attendant options for obtaining a high imaging quality may be obtained especially when the second plane of symmetry and the third plane of symmetry differ from the first plane of symmetry. The second plane of symmetry and the third plane of symmetry may be identical. Alternatively, provision may be made for the second plane of symmetry to differ from the third plane of symmetry. The planes of symmetry may be spaced apart from one another along the optical axis. In further embodiments, the first plane of symmetry and the third plane of symmetry may be identical to one another but different from the second plane of symmetry.

Within the scope of this disclosure, planes of symmetry that differ from one another may be spaced apart from one another along the optical axis by at least 1 cm, by at least 2 cm, by at least 5 cm, by at least 10 cm or even by at least 20 cm.

Furthermore, provision can be made for the correction elements to each comprise at least one third lens. In some embodiments, the third lens is manufactured from the first glass and/or from the second glass. In other embodiments, the third lens may also be manufactured from a third glass that differs from the first glass and/or second glass. In particular, the third glass may differ from a glass that exhibits normal dispersion within the meaning of this disclosure. At least a majority and/or all of the third lens may consist of the first glass, the second glass or the third glass. In this case, the second lens may be arranged between the first lens and the third lens. By preference, the first lens, the second lens and the third lens are arranged immediately in succession and in particular in contact with one another, and/or they are formed integrally with one another, for example optically bonded and/or adhesively bonded to one another.

Assembly outlay and/or number of components may be reduced especially when the correction elements are formed integrally with a respective rod lens. Expressed in general terms, at least one of the correction elements may be formed integrally with at least one of the rod lenses. In this case, “integral” comprises both in one piece and in one part. At least one lens of the relevant correction element may be formed integrally with the relevant rod lens. By preference, all lenses of the relevant correction element are formed integrally with the relevant rod lens. For example, the first lens may be arranged immediately next to the rod lens in these cases, and/or be optically bonded and/or adhesively bonded thereto. The arrangement may also be reversed, and so the second lens is arranged immediately next to the rod lens. Then, the second lens may additionally be arranged immediately next to the first lens and/or may be optically bonded and/or adhesively bonded thereto. In some embodiments, the correction element may be attached and/or bonded and/or adhesively bonded to a flat surface of the rod lens.

Moreover, the correction pair arrangement may comprise at least one aperture that is arranged in the region of the second plane of symmetry. An aperture of the lens arrangement may be expediently added as a result. In some variants, the second plane of symmetry intersects the aperture. In particular, the aperture has a smaller diameter than the rod lenses and/or the correction elements and/or the lenses of the correction elements. Statements as regards the symmetry of the lens arrangement may relate in particular to the components of the lens arrangement without the aperture, i.e. excluding the aperture. In other words, the lens arrangement may be symmetrical without the aperture, but the aperture may for example be arranged off center. In principle, a plurality of apertures may also be provided. In principle, these may be arranged symmetrically to one another in relation to one or any or all of the aforementioned planes of symmetry and/or may each be formed symmetrically thereto.

Depending on the configuration of the lens arrangement or of the optical system that defines the rod lenses and the correction elements, at least one of the first lenses and/or at least one of the second lenses may be a convex lens. In an alternative or in addition to that, at least one of the first lenses and/or at least one of the second lenses may be a concave lens. The second lenses may take identical forms. The first lenses may take identical forms.

A high image quality over a large spectral range can be obtained especially when the lens arrangement enables optical imaging in the range from 400 nm to 1000 nm with an RMS spot radius of no more than 40 μm, by preference no more than 35 μm and preferably no more than 30 μm. In particular, this may mean that a mean RMS spot radius is no more than 40 μm, by preference no more than 35 μm and preferably no more than 30 μm, for any desired chosen interval in this range with a width of no more than 50 nm, preferably no more than 40 nm, particularly preferably no more than 30 nm and by preference no more than 20 nm. Moreover, this may mean that an RMS spot radius is no more than 40 μm, by preference no more than 35 μm and preferably no more than 30 μm, for any desired wavelength.

In some embodiments, the lens arrangement may enable diffraction-limited optical imaging in the range from 480 nm to 1000 nm. In other words, the lens arrangement may be designed such that diffraction-limited optical imaging is made possible for any desired wavelength in the range from 480 nm to 1000 nm. In particular, diffraction-limited optical imaging is distinguished by virtue of a calculated RMS spot radius being less than or equal to a value defined by the diffraction limit.

The lens arrangement may have a largest RMS spot radius of no more than 8 μm, preferably of no more than 6 μm and by preference of no more than 4 μm, especially in the range from 480 nm to 1000 nm. In other words, an RMS spot radius may be no more than 8 μm, preferably no more than 6 μm and by preference no more than 4 μm, for any wavelength, especially in the range from 480 nm to 1000 nm.

The inventors have further identified that conventional lens arrangements sometimes have a good transmission in the visible range but exhibit significantly poorer transmission in the near infrared range. As a result, the usability of such conventional lens arrangements is significantly limited, especially for multispectral applications and hyperspectral applications, in which imaging should also be performed in the near infrared range. High-quality images in a broad spectral range may be rendered possible, especially if the rod lenses and the correction elements have antireflective surfaces that act in the visible range and in the near infrared range. In other words, the antireflective surfaces may be configured such that in contrast to antireflective surfaces that only optimize transmission in the visible range, a slightly lower transmission may be accepted in certain circumstances if in exchange the transmission remains at a high level even beyond the visible range, instead of reducing rapidly. Antireflective surfaces may comprise a coating of the relevant optical elements, for example an antireflective coating. In an alternative to that or in addition, a surface of the relevant optical elements itself may be treated, for example roughened on a microscopic and/or nanoscopic level.

In particular, provision may be made for the antireflective surfaces to each cause a mean reflection of no more than 2%, by preference no more than 1% and preferably no more than 0.6%, in the range from 400 nm to 1000 nm. In an alternative to that or in addition, provision may be made for the antireflective surfaces to each cause a maximum reflection of no more than 3%, by preference no more than 2% and preferably no more than 1%, in the range from 400 nm to 1000 nm.

The aforementioned antireflective surfaces may be present on at least one surface of at least one optical element in the lens arrangement, for example on at least one rod lens and/or on at least one correction element, for instance on at least one of the lenses. By preference, at least a plurality of the surfaces present are provided with antireflective surfaces, by preference this applies to all surfaces.

The lens arrangement may have a mean transmission of at least 70%, by preference at least 80% and particularly preferably at least 85%, in the range from 400 nm to 1000 nm. In an alternative to that or in addition, the lens arrangement may have a minimum transmission of at least 60%, by preference at least 70% and particularly preferably at least 80%, in the range from 400 nm to 1000 nm. As a result of this, light over a broad spectrum can be transmitted through the entire lens arrangement, whereby light both in the visible range and in the near infrared range may be transmitted efficiently.

The invention also relates to an endoscope having an endoscope device according to the invention and/or having a correction pair arrangement according to the invention. In some embodiments, the endoscope is configured to be insertable into a cavity for assessment and/or observation purposes, for example to be insertable into an artificial and/or natural cavity, for instance into an interior of the body, into a body organ, into tissue or the like. The endoscope may also be configured to be insertable into a housing, a casing, a shaft, a pipe or any other structure, in particular any other artificial structure, for assessment and/or observation purposes.

Further, the invention relates to an imaging system, in particular a medical imaging system. The imaging system comprises an illumination device that is configured to supply illumination light both in the visible range and in the near infrared range. Furthermore, the imaging system comprises an endoscope device according to the invention and/or an endoscope according to the invention. Moreover, the imaging system comprises an imaging device having an image capture unit that is configured to capture multispectral and/or hyperspectral image data. The image capture unit may comprise an image capture sensor system.

The imaging system may be multimodal. In particular, the imaging system may be configured to selectively record white-light images and/or multispectral images and/or fluorescence images and/or hyperspectral images.

The image capturing sensor system may be configured to detect light both in the visible range and in the near infrared range. A shortest detectable wavelength may be no more than 500 nm, no more than 450 nm or even no more than 400 nm in some embodiments. A longest detectable wavelength may be at least 800 nm, at least 900 nm or even at least 1000 nm in some embodiments. For example, the image capture sensor system may comprise at least one white-light image sensor and at least one near infrared image sensor. In some embodiments, the imaging device comprises a white-light camera and/or a sensor system for capturing white-light images. The imaging device may be configured for white-light imaging. The anatomical images may be recordable by means of the white-light camera and/or the sensor system for capturing white-light images.

The image capturing unit may comprise a filter unit with optical observation filters. The filter unit may define a plurality of fluorescence modes that are defined by different observation filters. For example, use can be made of different edge filters that absorb/block the respectively utilized spectrum of the associated luminous element used for excitation purposes and at least substantially transmit fluorescence only. The observation filter that blocks light in the first spectral range is part of the filter unit in that case. In some embodiments, the observation filters may be moreover switchable between a multispectral mode and a fluorescence mode.

The imaging device and in particular an optics unit and/or the image capture sensor system may be configured for multispectral and/or hyperspectral imaging, specifically for capturing and/or creating multispectral and/or hyperspectral image data. In this case, multispectral imaging or multispectral image data may relate in particular to imaging in which at least two, in particular at least three and in some cases at least five spectral bands can be and/or are captured independently of one another. In this case, hyperspectral imaging or hyperspectral image data may relate in particular to imaging in which at least 20, at least 50 or even at least 100 spectral bands can be and/or are captured independently of one another. The imaging device may operate according to the pushbroom method and/or according to the whiskbroom method and/or according to the staring method and/or according to a snapshot principle.

The ability to use a large spectral resolution may be advantageous for some applications. Hyperspectral imaging lends itself to that case. The latter may be combined with white-light imaging. This renders possible an observation in real time by way of a white-light image even if the capture of spectrally resolved image data is implemented only substantially in real time, i.e. for example if several seconds are required to create a spectrally resolved image. The creation of spectral image data in real time may be advantageous for some applications. For example, this includes the creation of a spectrally resolved image within less than one second or even several times per second. In this context, it may be expedient to resort to multispectral imaging. A possibly lower spectral resolution is then offset by a higher frame rate. Depending on the application, it may be sufficient to consider only a few different spectral ranges and/or wavelengths, for example two or three or four or generally less than ten. In this case, it is optionally possible to manage without additional white-light imaging. Spectrally resolved image data that are obtained in real time or supply several images per second may also be used for monitoring purposes, with an image to be reproduced not necessarily needing to be created for a user; instead, the image data may also be able to be processed in the background.

In particular, the image capture sensor system comprises at least one image sensor. Furthermore, the image capture sensor system may also comprise at least two image sensors and preferably a plurality of image sensors, which may be arranged in succession. Furthermore, the two image capture sensors and preferably the plurality of image capture sensors may have differently formed spectral capture sensitivities such that for example a first sensor is particularly sensitive or comparatively more sensitive in the red spectral range, a second sensor is particularly sensitive or comparatively more sensitive in a blue spectral range and a third sensor is particularly sensitive or comparatively more sensitive in a green spectral range, in each case in relation to the other sensors. For instance, the image sensor may take the form of a CCD sensor and/or a CMOS sensor.

In particular, the image capture unit is configured to create at least two-dimensional spatial image data. The image capture unit may have a spatial resolution to the effect that it in each case supplies a resolution of at least 100 picture elements, by preference at least 200 picture elements, preferably at least 300 picture elements and advantageously at least 400 picture elements, in at least two different spatial directions. By preference, the image data are at least three dimensional, with at least two dimensions being spatial dimensions and/or at least one dimension being a spectral dimension. A plurality of spatially resolved images of the image region may be obtainable from the image data, the images each being assigned to different spectral bands. The spatial and spectral information of the image data may be conditioned such that an associated spectrum is obtainable therefrom for each of the plurality of spatial picture elements.

In some embodiments, the image capture unit is configured to continually create updated image data. For example, the image capture unit may be configured to create the image data substantially in real time, this for example comprising a creation of updated image data at least every 30 seconds, at least every 20 seconds in some cases and even at least every 10 seconds in a few cases or at least every 5 seconds. By preference, the image capture unit is configured to create at least the anatomical images and the fluorescence images and the representation based thereon in real time, for example with a frame rate of at least 5 fps, at least 10 fps, at least 20 fps or even at least 30 fps.

The illumination device may have a multimodal design and comprise a plurality of luminous elements that are selectively activatable independently of one another and that are configured to emit light according to different emission spectra in order to supply the illumination light.

The illumination device may comprise an optical interface for optically connecting the endoscope. The illumination unit may be configured to supply illumination light to the optical interface. The illumination unit may have a multimodal design and comprise a plurality of luminous elements that are selectively activatable independently of one another and that are configured to emit light according to different emission spectra in order to supply the illumination light. The illumination unit may be operable in at least one multispectral mode, in which a first group of luminous elements is activated at least intermittently and in which the illumination unit supplies illumination light for multispectral imaging. Further, the illumination unit may be operable in at least one fluorescence mode, in which a second group of luminous elements is activated at least intermittently and in which the illumination unit supplies illumination light for fluorescence imaging. The luminous elements may comprise at least one luminous element contained both in the first group and in the second group.

Moreover, a method may be provided for creating illumination light for imaging equipment by means of an illumination device. In this case, the illumination device comprises an optical interface for optically connecting the endoscope and an illumination unit that is configured to supply illumination light to the optical interface, with the illumination unit comprising a plurality of luminous elements that are selectively activatable independently of one another and that are configured to emit light according to the different emission spectra in order to supply the illumination light. The method comprises the step of at least intermittent activation of a first group of luminous elements in order to supply illumination light for multispectral imaging and the step of at least intermittent activation of a second group of luminous elements in order to supply illumination light for fluorescence imaging. At least one of the luminous elements is at least intermittently activated both during the at least intermittent activation of the first group of luminous elements and during the at least intermittent activation of the second group of luminous elements.

The optical interface can be selectively detachable and connectable. Moreover, the optical interface may be combined with a mechanical interface such that an optical connection is for example established automatically whenever the endoscope is mechanically coupled.

The luminous elements may comprise monochrome LEDs (light-emitting diodes) and/or laser diodes. Furthermore, at least one of the luminous elements may be a white-light LED or any other white-light source. In some embodiments, the illumination unit comprises at least one blue luminous element, at least one red luminous element, at least one dark red luminous element and at least one near IR luminous element (near infrared luminous element), in particular respective LEDS or laser diodes. In addition, the illumination unit may comprise at least one white-light LED or any other white-light source.

The first group may comprise at least two luminous elements that emit spectrally differently. A high degree of efficiency during multispectral imaging may be obtained if the multispectral mode comprises different states in which a specific luminous element or a specific luminous element type is in each case activated at least intermittently. This allows illumination to be implemented in a specific spectral range in a targeted manner, whereby different spectral images may be captured. Different luminous elements that are activated in different states may serve as different sampling points for the multispectral imaging. At least one of these sampling points may be chosen such that it is matched to characteristic points of absorption spectra of physiologically relevant components, for example to an isosbestic point of the hemoglobin oxygenation curve. The multispectral imaging may additionally comprise the use of suitable observation filters.

Further, the second group may comprise at least two luminous elements that emit spectrally differently. The fluorescence mode may comprise different sub modes and/or states in which a specific luminous element or a specific luminous element type is in each case activated at least intermittently. This allows targeted excitation in a specific spectral range such that fluorescence imaging may for instance be implemented for a specifically selected dye. In other words, the at least one luminous element contained both in the first group and in the second group can thus be used both for the multispectral mode and for the fluorescence mode.

In some embodiments, the first group comprises only some but not all of the luminous elements. In an alternative to that or in addition, the second group comprises only some but not all of the luminous elements in some embodiments. In the multispectral mode, it is in particular only luminous elements of the first group that are at least intermittently activated, whereas luminous elements that do not belong to the first group are deactivated. In the fluorescence mode, it is in particular only luminous elements of the second group that are at least intermittently activated, whereas luminous elements that do not belong to the second group are deactivated. In general, it is understood that the luminous elements may comprise different luminous element types and that exactly one luminous element from each of the different luminous element types may be present. It is understood that mixed operating modes may also arise according to the invention; in these, the aforementioned modes are used sequentially. For example, multispectral imaging and fluorescence imaging may be performed sequentially.

Synergy in respect of the use of a luminous element for different modes and efficiency gains connected therewith may be obtained in particular whenever at least one luminous element that is contained both in the first group and in the second group emits light in the red spectral range, in particular in a spectral range between 600 nm and 680 nm, for example between 610 nm and 650 nm or between 620 and 660 nm or between 630 and 670 nm. The spectral range may be narrowband and comprise the wavelength of 660 nm. “Narrowband” may comprise a spectral width of no more than 80 nm, in particular no more than 40 nm or even no more than 20 nm. This at least one luminous element may be configured to excite dyes that absorb in the red spectral range and supply a contribution to the illumination in the red spectral range for multispectral imaging.

In some embodiments, the illumination unit may be operable in at least one white-light mode, in which the illumination unit supplies illumination light for white-light imaging. The illumination light for white-light imaging may be broadband white light. In an alternative, the illumination light for white-light imaging may comprise a plurality of narrow wavelength bands that are separated from one another, for example a blue, a red and a dark red band. In this context, “dark red” should be understood in the sense of “longer wavelength than red” and relates to the spectral position and not the luminous intensity. The illumination light for white-light imaging may be mixed from light from different luminous elements.

In the white-light mode, a third group of luminous elements may be activated at least intermittently in order to supply the illumination light for white-light imaging. In this case, the luminous elements may comprise at least one luminous element contained both in the first and/or second group and also in the third group. In some cases, the third group may comprise only some but not all of the luminous elements. In the white-light mode, it is in particular only luminous elements of the third group that are at least intermittently activated, whereas luminous elements that do not belong to the third group are deactivated. In other words, the illumination unit may comprise luminous elements that serve one, two or all three of the specified illumination modes. As a result, a plurality of luminous elements may be used multiple times.

At least one luminous element contained both in the first and/or second group and in the third group may emit light in the red spectral range, in particular in a spectral range between 600 nm and 680 nm, for example between 610 nm and 650 nm or between 620 and 660 nm or between 630 and 670 nm. The advantages of the joint use of luminous elements come particularly to bear when at least one red luminous element is usable for all three modes.

At least one luminous element contained both in the first and/or second group and in the third group may emit light in the blue spectral range, in particular in a spectral range between 440 and 480 nm. Expediently, at least one blue luminous element can be used both in the fluorescence mode and in the white-light mode.

Expressed in general terms, the luminous elements as mentioned may comprise at least one luminous element, in particular at least one blue luminous element, which emits light in a spectral range between 440 and 480 nm. Moreover, as mentioned, the luminous elements may comprise at least one luminous element, in particular at least one red luminous element, which emits light in a spectral range between 600 and 680 nm, for example between 610 nm and 650 nm or between 620 and 660 nm or between 630 and 670 nm. In an alternative to that or in addition, the luminous elements may comprise at least one luminous element, in particular at least one dark red luminous element, which emits light in a spectral range between 750 and 790 nm. In an alternative to that or in addition, luminous elements may comprise at least one luminous element, in particular at least one near IR-emitting luminous element, which emits light in a spectral range between 920 and 960 nm. In addition, the luminous elements may comprise a white-light luminous element. A compact and versatile illumination unit may be provided in particular whenever at least one luminous element of each of the aforementioned luminous element types is present. For example, the blue and the red luminous elements, and optionally also the dark red luminous element in the case of suitable dyes, may be usable in the fluorescence mode. The dark red and the near IR-emitting luminous elements may be usable in the multispectral mode. The white-light luminous element may be usable in the white-light mode. In the white-light mode, said white-light luminous element may be supplemented by the blue luminous element and optionally the red luminous element as well. In this way, colored luminous elements may be used to supplement wavelength ranges in which the white-light luminous element supplies a reduced intensity, for example on account of its structure but in particular on account of filters and optical elements of the illumination unit. Moreover, the colored illumination elements may be used to set a color temperature within the scope of white-light imaging.

In some embodiments, the second group comprises a single luminous element and/or a single type of luminous elements. For example, provision may be made for a white-light luminous element, a red luminous element and an IR-emitting luminous element, with reference being made to the aforementioned values in particular in respect of possible spectral ranges. In that case, the first group may for example comprise the red and the IR-emitting luminous element. The second group may comprise the IR-emitting luminous element, in particular as a single luminous element or as single type of luminous element.

An expedient arrangement of luminous elements is rendered possible in particular whenever the illumination unit comprises at least one crossed beam splitter that renders the light deflectable from opposite input sides to one output side, with at least one of the luminous elements being arranged in each case on the opposite input sides of the crossed beam splitter. In some embodiments, two or even more crossed beam splitters may be provided and arranged optically in succession. The at least one crossed beam splitter may comprise two beam splitter elements, the transmissivity of which is matched to the luminous element assigned in each case. In particular, the beam splitter elements each comprise a notch filter, and so they each reflect in a narrow spectral band but are otherwise transmissive. The spectral position and/or width of the corresponding notch may be matched to the spectral range of the luminous element assigned in each case, and so the light from the latter is deflected but light from other luminous elements is at least substantially transmitted.

In some embodiments, the luminous elements may comprise at least four narrowband-emitting individual color luminous elements with different spectral ranges in each case and at least one broadband-emitting white-light luminous element. In this respect, reference is also made to the explanations given above in relation to the colored luminous elements.

A great range of functions in combination with a compact structure and the use of synergistic effects when using luminous elements may be obtained in particular whenever the illumination unit is operable in at least one hyperspectral mode, in which a plurality of luminous elements whose emission spectra jointly cover at least a spectral range from 450 nm to 850 nm are activated and in which the illumination unit supplies illumination light for hyperspectral imaging. In particular, these may be all of the luminous elements.

It is understood that suitable polarization filters may be used for the optical filters specified herein, especially in the case where laser diodes are used. Furthermore, at least one crossed beam splitter whose beam splitter elements are provided with polarization filters may be used, especially in the case where laser diodes are used. In that case, selective transmissivity can be obtained by a combination of different polarizations.

Here, it is not the intention for the devices and systems according to the invention and the methods according to the invention to be restricted to the use and embodiment described above. In particular, in order to perform a function described herein, they can have a number of individual elements, components and units and method steps that deviates from a number stated herein. Moreover, as regards the value ranges specified in this disclosure, values lying within the limits mentioned will also be deemed to be disclosed and to be usable as desired.

It is pointed out in particular that all features and properties but also procedures described in relation to a device are analogously applicable to methods and can be used within the meaning of the invention and are deemed to be concomitantly disclosed. The same applies conversely as well. This means that structural, i.e. device-pertaining features, mentioned with regard to the method can also be taken into account, claimed and likewise included as part of the disclosure within the scope of the device claims.

The present invention is described below by way of example and with reference to the accompanying figures. The drawing, the description and the claims contain numerous features in combination. A person skilled in the art will advantageously also consider the features individually and use them in a meaningful way in combination within the scope of the claims.

If there is more than one instance of a given object, only one of them may be referenced in the figures and in the description. The description of this instance can be transferred accordingly to the other instances of the object. If objects are named in particular by means of numerical words, such as first, second, third object, etc., these are used to name and/or assign objects. Thus, for example, a first object and a third object might be included, but no second object. However, a number and/or a sequence of objects could also be derived from numerical words.

In detail:

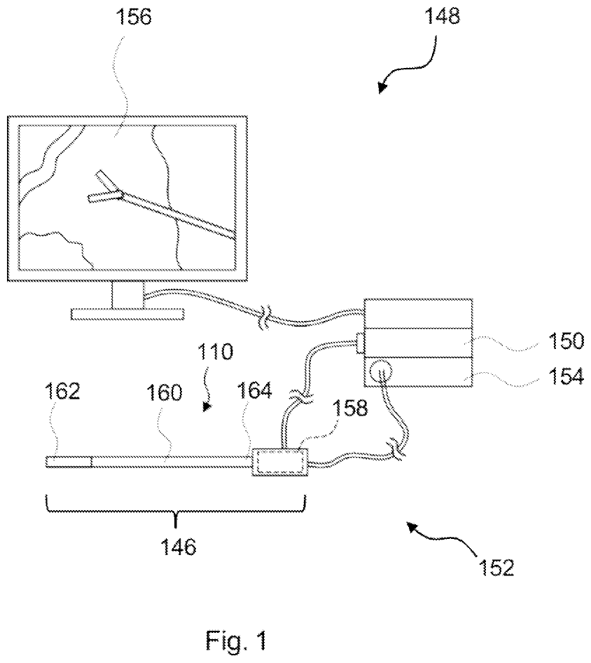

FIG. 1 shows a schematic illustration of an imaging system with an illumination device, an endoscope with an endoscope device and an image capture device;

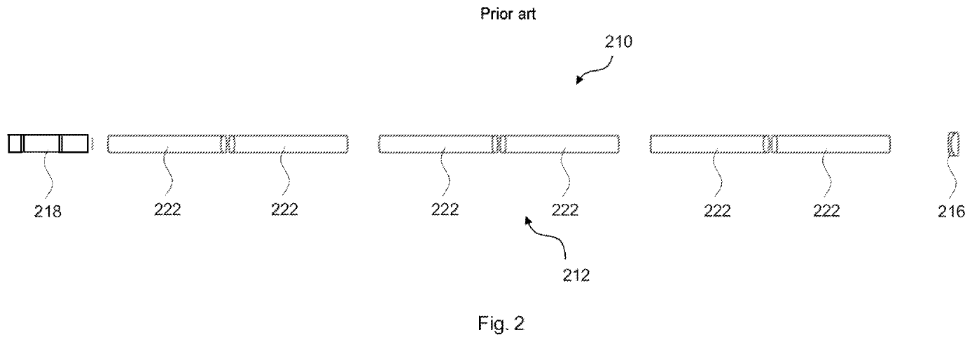

FIG. 2 shows a schematic illustration of a lens arrangement of an endoscope device according to the prior art;

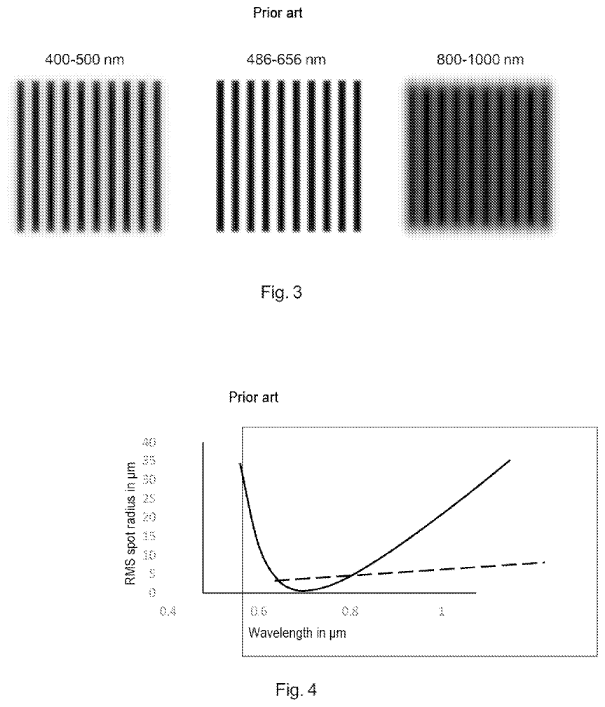

FIG. 3 shows a schematic illustration of images of a line pattern, implemented using the lens arrangement according to the prior art;

FIG. 4 shows a diagram pertaining to the wavelength-dependence of an RMS spot radius of the lens arrangement according to the prior art;

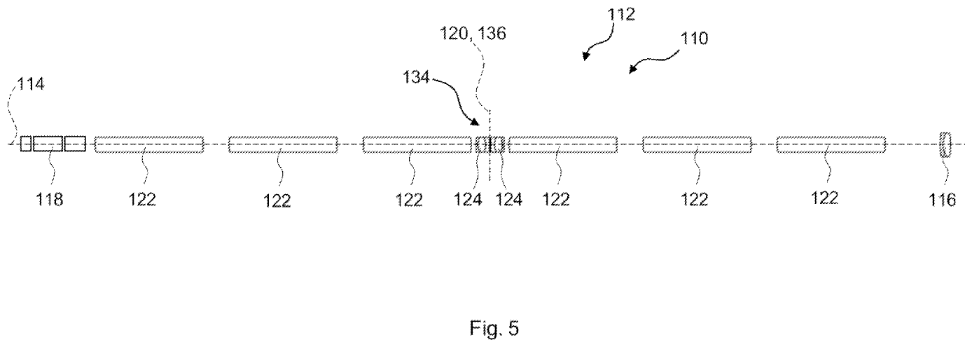

FIG. 5 shows a schematic illustration of a first endoscope device;

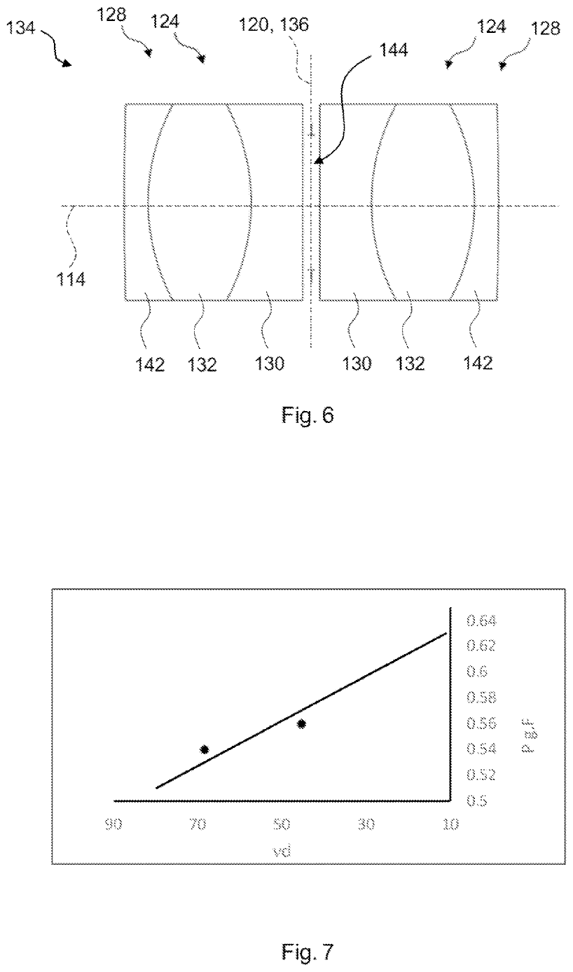

FIG. 6 shows a schematic illustration of a correction pair arrangement of the first endoscope device;

FIG. 7 shows a diagram for elucidating the selection of glass for the correction pair arrangement;

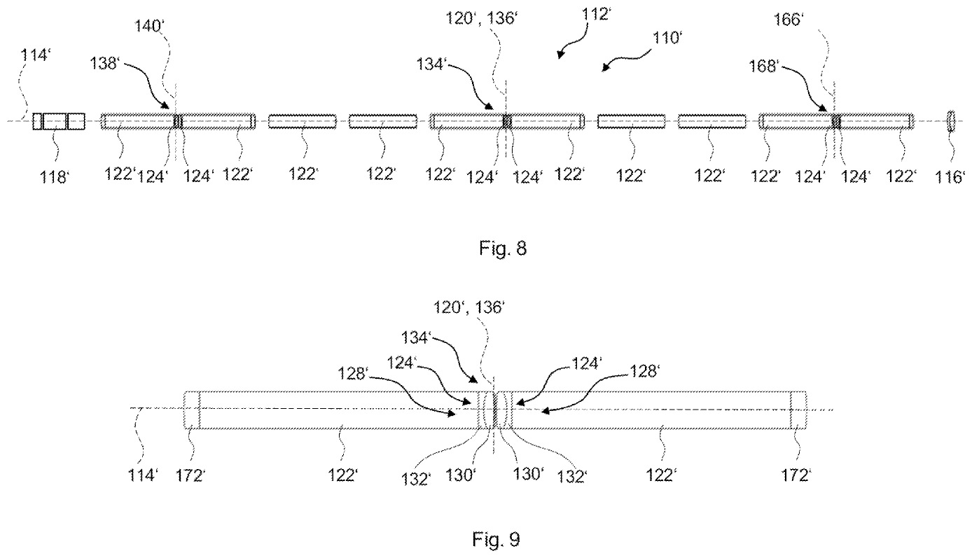

FIG. 8 shows a schematic illustration of a second endoscope device;

FIG. 9 shows a schematic illustration of a correction pair arrangement of the second endoscope device;

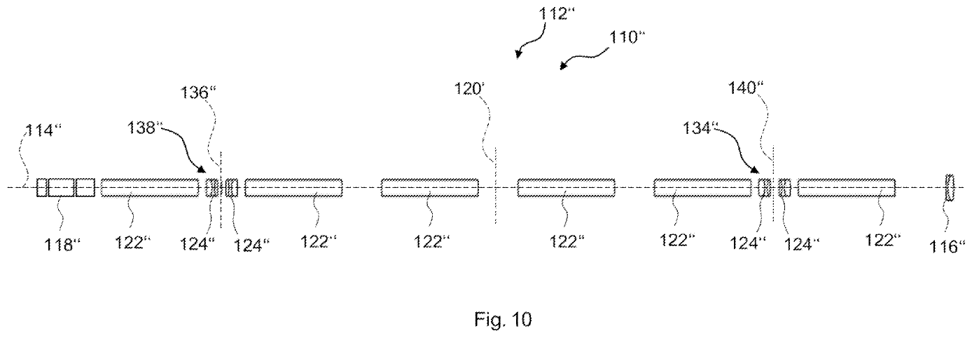

FIG. 10 shows a schematic illustration of a third endoscope device;

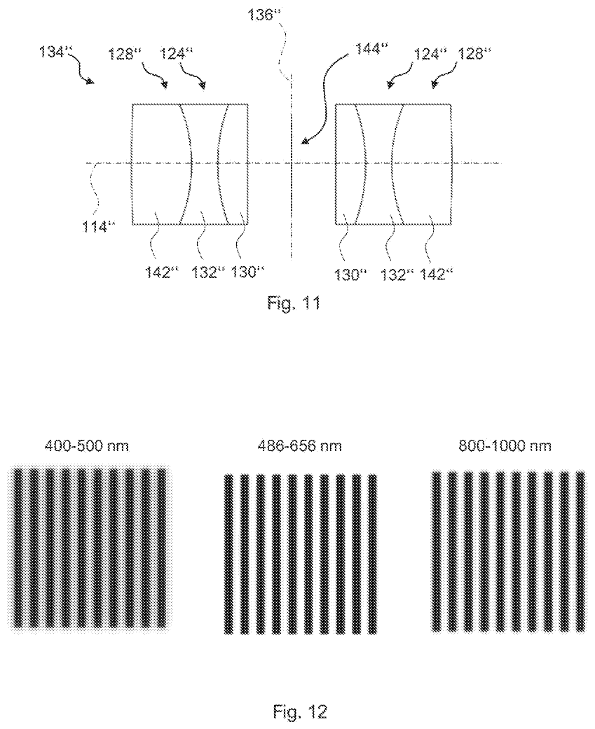

FIG. 11 shows a schematic illustration of a correction pair arrangement of the third endoscope device;

FIG. 12 shows a schematic illustration of images of a line pattern, implemented using the first endoscope device, the second endoscope device or the third endoscope device;

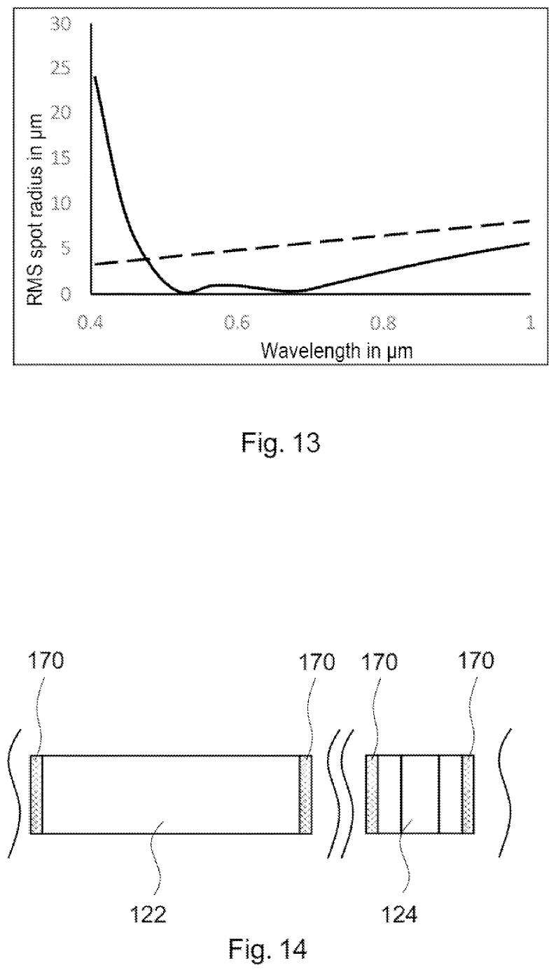

FIG. 13 shows a diagram pertaining to the wavelength-dependence of an RMS spot radius of the first endoscope device, the second endoscope device or the third endoscope device;

FIG. 14 shows a schematic illustration of a lens arrangement with antireflective surfaces;

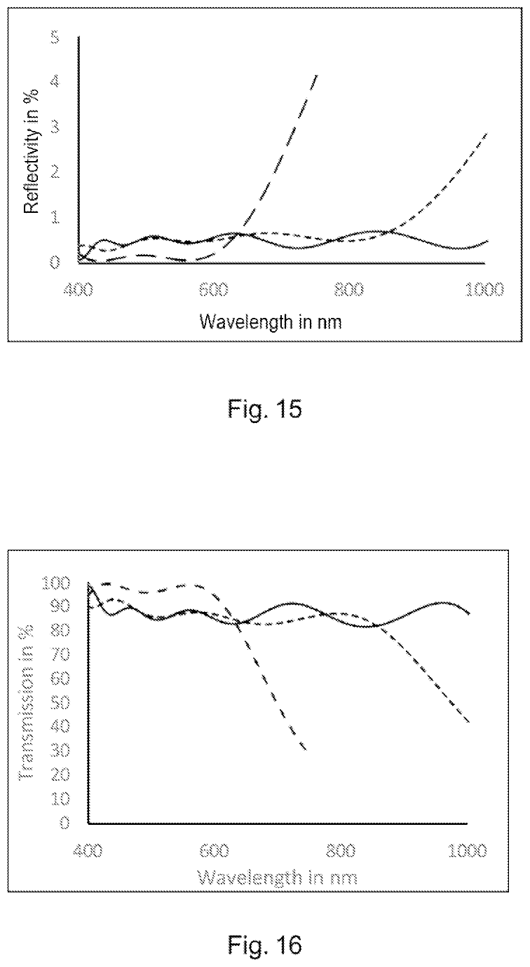

FIG. 15 shows a schematic diagram elucidating different reflectivity curves;

FIG. 16 shows a schematic diagram elucidating different transmission curves;

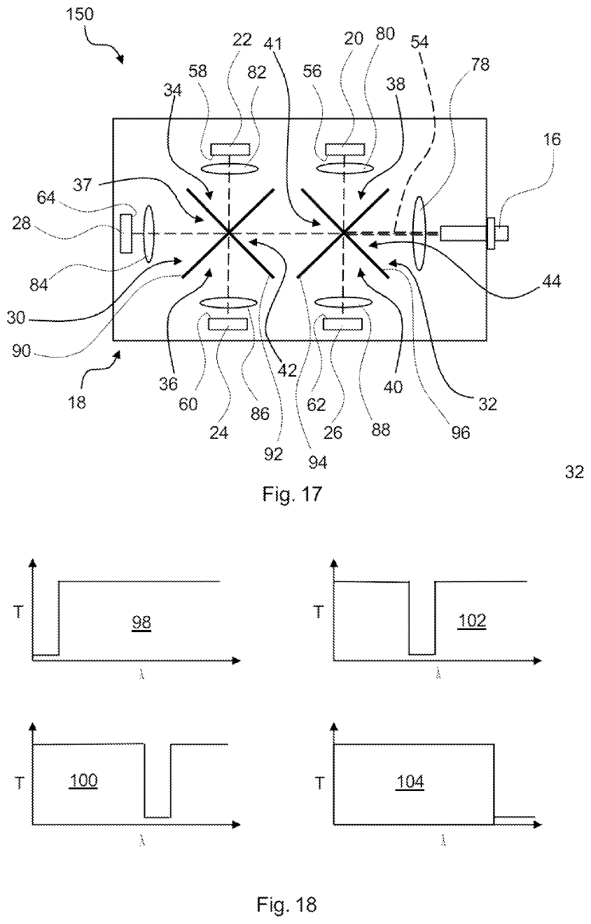

FIG. 17 shows a schematic illustration of the illumination device 150; and

FIG. 18 shows schematic transmission curves of beam splitter elements of the illumination device.

FIG. 1 shows a schematic illustration of an imaging system 148. The imaging system 148 is an endoscopic imaging system. The imaging system 148 may be a medical imaging system. In the present case, the imaging system 148 is a multispectral and/or hyperspectral endoscopic imaging system.

The imaging system 148 comprises an illumination device 150, an endoscope device 110 and an imaging device 152 with an image capture unit 154. The image capture unit 154 is configured to capture multispectral and/or hyperspectral image data. To this end, the image capture unit 154 comprises a suitable image capture sensor system 158, which is merely depicted by way of example.

The image capture sensor system 158 may comprise a CMOS or CCD sensor (not depicted here). The image capture sensor system 158 and optional associated optical elements may be arranged in a pushbroom arrangement. A whiskbroom arrangement, a staring arrangement and/or a snapshot arrangement is used in other embodiments. As regards different methods of hyperspectral imaging and components required to this end, reference is made to the specialist article “Review of spectral imaging technology in biomedical engineering: achievements and challenges” by Quingli Li et al., published in Journal of Biomedical Optics 18(10), 100901, October 2013, and to the specialist article “Medical hyperspectral imaging: a review” by Guolan Lu and Baowei Fei, published in Journal of Biomedical Optics 19(1), 010901, January 2014.

As mentioned, the image capture unit 154 may also be multispectral in other embodiments. For example, a plurality of spectral ranges may be observed by using filters that are optionally introducible into an object light beam path and/or by using sequential illumination at different wavelengths.

The endoscope device 110 is part of an endoscope 146. The endoscope 146 may comprise parts of the image capture unit 154. The endoscope device 110 comprises a shaft 160. The shaft 160 is configured to accommodate a lens arrangement that is configured to guide imaging light from a distal end 162 of the endoscope device 110 and/or of the shaft 160 to a proximal end 164 of the endoscope device 110 and/or of the shaft 160. This will be discussed hereinafter. The shaft 160 may be rigid. In particular, the endoscope 146 is a rigid endoscope, and/or the endoscope device 110 is an endoscope device for a rigid endoscope.

FIG. 2 shows a schematic illustration of a lens arrangement 212 of an endoscope device 210 according to the prior art. The endoscope device 212 comprises an eyepiece 216 and an objective 218. The lens arrangement 212 couples the eyepiece 216 and the objective 218 in a manner known per se. Light collected by the objective 218 may be transmitted to the eyepiece 216 through the lens arrangement 212. An image can be created in this way.

The lens arrangement 212 comprises a plurality of rod lenses 222. The lens arrangement 212 is predominantly provided for transmitting and imaging light in the visible range, for example in a range from 450 nm to 750 nm.

FIG. 3 shows a schematic illustration of images of a line pattern, implemented using the lens arrangement 212 according to the prior art. FIG. 4 shows a diagram pertaining to the wavelength-dependence of an RMS spot radius of the lens arrangement 212. It is evident that the RMS spot radius is small and even below the diffraction limit, which is plotted using a dashed line in FIG. 4, in a mid-wavelength range. When the line pattern is imaged, the image shown in the center of FIG. 3 arises for the mid-wavelength range, presently for example for light at wavelengths between 486 nm and 656 nm. In this case, a sharp image of the line pattern can be obtained since the lens arrangement 212 images well in this range. However, a likewise sharp image cannot be obtained simultaneously for shorter and longer wavelengths on account of lens errors, in particular on account of chromatic aberration. The RMS spot radius is significantly larger in these ranges, leading to blurred imaging. On the left-hand side of FIG. 3, this is depicted in exemplary fashion for the wavelength range from 400 nm to 500 nm, while the right-hand side shows the wavelength range from 800 nm to 1000 nm by way of example. The imaging quality is quite low in the near infrared range, i.e. in the range mentioned last, and so geometric features cannot be imaged in detail.

The conventional endoscope device 210 is therefore predominantly usable in the visible range. For example, an imaging quality may be sufficient if it is used for white-light imaging, which approximately corresponds to a combination of the cases shown to the left and in the center of FIG. 3. However, if imaging should also be performed in the near infrared, the quality might under certain circumstances not be sufficient to obtain meaningful image data, on the basis of which e.g. anatomical properties of an examined anatomy of a patient could be assessed.

FIG. 5 shows a schematic illustration of a first endoscope device 110 according to the present disclosure. The first endoscope device 110 can be used both in the visible range and in the near infrared range. The endoscope device 110 comprises a lens arrangement 112, an eyepiece 116 and an objective 118. In the present case, these are arranged in the shaft 160, which is shown in FIG. 1. The lens arrangement 112 optically couples the eyepiece 116 and the objective 118. Hence, at least in a range between 480 nm and 1000 nm, preferably in a range between 400 nm and 1000 nm, light can be transmitted and imaged substantially equivalently by the lens arrangement 112.

The lens arrangement 112 comprises six rod lenses 122. The lens arrangement 112 also comprises two correction elements 124. The lens arrangement 112 defines an optical axis 114. The rod lenses 122 and the correction elements 124 are arranged coaxially with respect to the optical axis 114. In the depicted case, the rod lenses 122 and the correction elements 124 each have a circular cross section, the center of which is located on the optical axis 114.

The lens arrangement 112 is symmetrical with respect to a first plane of symmetry 120. The first plane of symmetry 120 is perpendicular to the optical axis 114.

The two correction elements 124 are part of or form a correction pair arrangement 134. The two correction elements 124 of the correction pair arrangement 134 are arranged symmetrically to one another in relation to a second plane of symmetry 136. In this embodiment, the second plane of symmetry 136 corresponds to the first plane of symmetry.

The correction pair arrangement 134 is depicted in more detail in FIG. 6. Each correction element 124 of the correction pair arrangement 134 comprises a first lens 130, a second lens 132 and a third lens 142. They form a lens triplet. The first lens 130, the second lens 132 and the third lens 142 have an integral embodiment, for example as a result of adhesive bonding and/or optical bonding. Together they form a lens system 128.

The first lens 130 is manufactured from a first glass and the second lens 132 is formed from a second glass. The first glass and the second glass are chosen such that they deviate in the opposite sense from glass with a normal dispersion. This is depicted schematically in FIG. 7. FIG. 7 shows a diagram in which the relative partial dispersion P_{g,F} is plotted against the Abbe number ν_{d}. The solid line defines those points on which glass with normal dispersion is located. In this respect, reference is made in particular to the explanations given above as regards glass with normal and abnormal dispersion. The first glass and the second glass are situated at positions in the diagram that are depicted by the two black dots in FIG. 7. The first glass is located to the right of the line at a large Abbe number and deviates from glass with normal dispersion in a first direction. The second glass is located to the left of the line at a small Abbe number and deviates from glass with normal dispersion in a second direction opposite to the first.

For example, the first glass has an Abbe number ν_{d} of 63.66, a refractive index n_{D} of 1.61800 and a dispersion n_{F}−n_{C} of 0.009758. For example, the second glass has an Abbe number ν_{d} of 42.41, a refractive index n_{D} of 1.63775 and a dispersion n_{F}−n_{C} of 0.015038. Hence, the two glasses are deliberately chosen to be different and deliberately chosen in such a way that they have opposite deviations from normal dispersion. As a result, the lens arrangement 112 may supply high-quality images over a broad spectral range.

In the present embodiment, the third lens 142 is likewise manufactured from the first glass.

The first lens 130 is a concave lens. The second lens 132 is a convex lens. The third lens 142 is a concave lens. By way of example, the first lens 130 has a radius of curvature of −6 mm. Further, by way of example, the second lens 132 has a radius of curvature of 6 mm. Furthermore, by way of example, the third lens 142 has a radius of curvature of 90 mm.

The correction pair arrangement 134 comprises an aperture 144 that is arranged in the region of the second plane of symmetry 136. The aperture 144 has a smaller diameter than the rod lenses 112 and the correction elements 124.

FIG. 8 shows a schematic illustration of a second endoscope device 110′ according to the present disclosure. To aid distinguishability, the reference signs of this embodiment have been provided with an apostrophe. For as long as no other description is provided, reference as regards the components present may also be made, as a matter of principle, to the explanations given above. The second endoscope device 110′ can be used both in the visible range and in the near infrared range. The second endoscope device 110″ comprises a lens arrangement 112′, an eyepiece 116′ and an objective 118′. In the present case, these are arranged in the shaft 160, which is shown in FIG. 1. The lens arrangement 112′ optically couples the eyepiece 116′ and the objective 118′. Hence, at least in a range between 480 nm and 1000 nm, preferably in a range between 400 nm and 1000 nm, light can be transmitted and imaged substantially equivalently by the lens arrangement 112′.

The lens arrangement 112′ comprises ten rod lenses 122′. The lens arrangement 112′ also comprises six correction elements 124′. The lens arrangement 112′ defines an optical axis 114′. The rod lenses 122′ and the correction elements 124′ are arranged coaxially with respect to the optical axis 114′. In the depicted case, the rod lenses 122′ and the correction elements 124′ each have a circular cross section, the center of which is located on the optical axis 114′.

The lens arrangement 112′ is symmetrical with respect to a first plane of symmetry 120′. The first plane of symmetry 120′ is perpendicular to the optical axis 114′.

Two of the correction elements 124′ are part of or form a correction pair arrangement 134′. The two correction elements 124′ of the correction pair arrangement 134′ are arranged symmetrically to one another in relation to a second plane of symmetry 136′. In this embodiment, the second plane of symmetry 136′ corresponds to the first plane of symmetry.

Two further correction elements 124′ in each case form two further correction pair arrangements 138′, 168′. These are symmetrical to one another in relation to a third plane of symmetry 140′ and a fourth plane of symmetry 166′, respectively. The third plane of symmetry 140′ and the fourth plane of symmetry 166′ each are perpendicular to the optical axis 114′.

The two further correction pair arrangements 138″, 168″ are arranged and/or formed symmetrically in relation to the first plane of symmetry 120″. Further, as mentioned, the correction pair arrangement 134″ is symmetrical in relation to the first plane of symmetry 120″. Hence, the six correction elements 124″ of this embodiment are arranged symmetrically in relation to the first plane of symmetry 120″.

The correction pair arrangement 134′ is depicted in more detail in FIG. 9. Each correction element 124′ of the correction pair arrangement 134′ comprises a first lens 130′ and a second lens 132′. The first lens 130′ and the second lens 132′ have an integral embodiment, for example as a result of adhesive bonding and/or optical bonding. Together they form a lens system 128′.

The first lens 130′ is manufactured from a first glass and the second lens 132′ is formed from a second glass. The first glass and the second glass are chosen such that they deviate in the opposite sense from glass with a normal dispersion. In this respect, reference is made again to FIG. 7 for elucidation purposes.

For example, the first glass has an Abbe number ν_{d} of 42.41, a refractive index n_{D} of 1.63775 and a dispersion n_{F}−n_{C} of 0.015038. For example, the second glass has an Abbe number ν_{d} of 63.33, a refractive index n_{D} of 1.61800 and a dispersion n_{F}−n_{C} of 0.009758. Hence, the two glasses are deliberately chosen to be different and deliberately chosen in such a way that they have opposite deviations from normal dispersion. As a result, the lens arrangement 112′ may supply high-quality images over a broad spectral range.

The first lens 130′ is a convex lens. The second lens 132′ is a concave lens. By way of example, the first lens 130′ has a radius of curvature of 12 mm. Further, by way of example, the second lens 132′ has a radius of curvature of −4.8 mm.

The correction pair arrangement 134′ comprises an aperture 144′ that is arranged in the region of the second plane of symmetry 136′. The aperture 144′ has a smaller diameter than the rod lenses 112 and the correction elements 124.

In the present embodiment, the correction elements 124′ are in each case formed integrally with a rod lens 122′. By way of example, they are adhesively bonded and/or optically bonded to an end face, in particular a flat end face, of the relevant rod lens 122′.

A further lens 172′ that is part of the rod lens 122′ is arranged on an opposite side to the respective correction element 124′. Said further lens is adhesively bonded and/optically bonded to a main body of the rod lens 122′. In the present case, the main body of the rod lens 122′ is manufactured from a glass that has an Abbe number ν_{d} of 50.19 and a refractive index n_{D} of 1.62658. The main body of the rod lens 122′ comprises flat end faces. The further lens 172′ is manufactured from a glass that has an Abbe number ν_{d} of 49.34, a refractive index n_{D} of 1.74320 and a dispersion n_{F}−n_{C} of 0.015063. The further lens 172′ is a concave lens and, by way of example, has a radius of curvature of 13.7 mm.

FIG. 10 shows a schematic illustration of a third endoscope device 110″ according to the present disclosure. To aid distinguishability, the reference signs of this embodiment have been provided with two apostrophes. For as long as no other description is provided, reference as regards the components present may also be made, as a matter of principle, to the explanations given above. The third endoscope device 110″ can be used both in the visible range and in the near infrared range. The third endoscope device 110″ comprises a lens arrangement 112″, an eyepiece 116″ and an objective 118″. In the present case, these are arranged in the shaft 160, which is shown in FIG. 1. The lens arrangement 112″ optically couples the eyepiece 116″ and the objective 118″. Hence, at least in a range between 480 nm and 1000 nm, preferably in a range between 400 nm and 1000 nm, light can be transmitted and imaged substantially equivalently by the lens arrangement 112″.

The lens arrangement 112″ comprises six rod lenses 122″. The lens arrangement 112″ also comprises four correction elements 124″. The lens arrangement 112″ defines an optical axis 114″. The rod lenses 122″ and the correction elements 124″ are arranged coaxially with respect to the optical axis 114″. In the depicted case, the rod lenses 122″ and the correction elements 124″ each have a circular cross section, the center of which is located on the optical axis 114″.

The lens arrangement 112″ is symmetrical with respect to a first plane of symmetry 120″. The first plane of symmetry 120″ is perpendicular to the optical axis 114″.

Two of the correction elements 124″ are part of or form a correction pair arrangement 134″. The two correction elements 124″ of the correction pair arrangement 134″ are arranged symmetrically to one another in relation to a second plane of symmetry 136″. The second plane of symmetry 136″ differs from the first plane of symmetry 120″. The second plane of symmetry 136″ is perpendicular to the optical axis 114″.

Two further correction elements 124″ are part of or form a further correction pair arrangement 138″. The two correction elements 124″ of the further correction pair arrangement 138″ are arranged symmetrically to one another in relation to a third plane of symmetry 140″. The third plane of symmetry 140″ differs from the first plane of symmetry 120″ and from the second plane of symmetry 136″. The third plane of symmetry 140″ is perpendicular to the optical axis 114″.

The correction pair arrangement 134″ and the further correction pair arrangement 138″ are arranged and/or formed symmetrically in relation to the first plane of symmetry 120″. In this embodiment, provision can be made for no correction pair arrangement to be present in the region of the first plane of symmetry 120″.

The correction pair arrangement 134″ is depicted in more detail in FIG. 11. Each correction element 124″ of the correction pair arrangement 134″ comprises a first lens 130″, a second lens 132″ and a third lens 142″. They form a lens triplet. The first lens 130″, the second lens 132″ and the third lens 142″ have an integral embodiment, for example as a result of adhesive bonding and/or optical bonding. Together they form a lens system 128″.

The first lens 130″ is manufactured from a first glass and the second lens 132 is formed from a second glass. The first glass and the second glass are chosen such that they deviate in the opposite sense from glass with a normal dispersion. In this respect, reference is made again to FIG. 7 for elucidation purposes.

For example, the first glass has an Abbe number ν_{d} of 59.71, a refractive index n_{D} of 1.53996 and a dispersion n_{F}−n_{C} of 0.009120. For example, the second glass has an Abbe number ν_{d} of 63.33, a refractive index n_{D} of 1.61800 and a dispersion n_{F}−n_{C} of 0.009758. Hence, the two glasses are deliberately chosen to be different and deliberately chosen in such a way that they have opposite deviations from normal dispersion. As a result, the lens arrangement 112″ may supply high-quality images over a broad spectral range.

In the present embodiment, the third lens 142″ is manufactured from a third glass that differs from the first glass and the second glass. For example, the third glass has an Abbe number ν_{d} of 47.11, a refractive index n_{D} of 1.67003 and a dispersion n_{F}−n_{C} of 0.014380.

The first lens 130″ is a convex lens. The second lens 132″ is a concave lens. The third lens 142″ is a convex lens. By way of example, the first lens 130″ has a radius of curvature of 8.5 mm. Further, by way of example, the second lens 132″ has a radius of curvature of −7.8 mm. Furthermore, by way of example, the third lens 142″ has a radius of curvature of 82 mm.

The correction pair arrangement 134″ comprises an aperture 144″ that is arranged in the region of the second plane of symmetry 136″. The aperture 144″ has a smaller diameter than the rod lenses 112″ and the correction elements 124″.

In the present case, no aperture is arranged in the region of the further correction pair arrangement 138″. However, in other embodiments an aperture may be arranged in the region of the further correction pair arrangement 138″, in an alternative to the aperture 144′ of the first correction pair arrangement 134″ or in addition to that.

FIG. 12 shows a schematic illustration of images of a line pattern, implemented using the first endoscope device 110, the second endoscope device 110′ or the third endoscope device 110″. In contrast to the imaging of a line pattern using a lens arrangement according to the prior art, explained above, comparatively sharp imaging of the line pattern is possible over the entire spectral range between 400 nm and 100 nm. The combination of the suitably chosen glasses and the configuration and arrangement of the correction elements or correction pair arrangements allows high-quality imaging over a broad spectral range.

FIG. 13 shows a diagram pertaining to the wavelength-dependence of an RMS spot radius of the first endoscope device 110, the second endoscope device 110′ or the third endoscope device 110″. The diffraction limit is plotted as a dashed line. It is evident that the RMS spot radius is below the diffraction limit, at least in a range between 480 nm and 1000 nm. The RMS spot radius increases at the blue edge of the range from 400 nm to 1000 nm but is below 25 μm. From this, it is evident why the high-quality images of the line pattern depicted in FIG. 12 arise for the different spectral ranges.

FIG. 14 shows a schematic illustration of a lens arrangement 112 with antireflective surfaces 170. Such antireflective surfaces 170 may be used in each of the embodiments described above. FIG. 15 shows a schematic diagram elucidating different reflectivity curves. The two dashed lines show conventional coatings that are optimized to act in the visible range or just therebeyond. Although little reflectivity may be obtained in the visible range, this is accompanied by a sharp increase in the reflectivity in the red or near infrared range. Such antireflective surfaces only have limited suitability for multispectral imaging, hyperspectral imaging, combined white-light imaging and fluorescence imaging or any other imaging for which imaging should be possible over a broad spectral range.

This is evident from FIG. 16 in particular, which shows a schematic diagram elucidating different transmission curves. The transmission curves were calculated for a lens arrangement which comprises 30 surfaces by way of example. Each surface has been provided with antireflective surfaces that exhibit the reflectivity curves depicted as dashed lines in FIG. 15. On account of the large number of surfaces, the losses at the individual surfaces add up, and the transmission drops rapidly in the red and in the near infrared range.

By contrast, antireflective surfaces characterized by the curves depicted using solid lines in FIGS. 15 and 16 may be used in the above-described endoscope devices 110, 110′, 110″. In this case, it is evident that the reflectivity in the range between 400 nm and 1000 nm possibly lies above the values for a surface that was optimized for the visible range but is at a low level over the entire range in return. Specifically, the reflectivity is no more than 1% over the entire range. This leads to a transmission at likewise a high level over the entire range, at least above 75% in the present case.

As mentioned, the endoscope devices 110, 110′, 110″ are particularly advantageous especially when used for imaging in which a broad spectral range is considered, or at least wavelength ranges that are distributed over a broad spectral range. Therefore, it may be advantageous to use an illumination device 150 that is usable over a broad bandwidth and preferably multimodal. This is described in detail by way of example below. However, it is understood that the endoscope devices 110, 110′, 110″ may also be combined with other suitable illumination devices.

As mentioned, the illumination device 150 may be multimodal. The illumination device 150 is operable in different illumination modes, in which it supplies light for different imaging modes. In the present case, the illumination device 150 is operable in three fundamental modes: a multispectral mode, a fluorescence mode and a white-light mode. The imaging device 152 is also operable in different operating modes, specifically likewise at least in a multispectral mode, a fluorescence mode and a white-light mode. In the corresponding operating mode of the imaging device 152, the modes of the illumination device 150 are matched to one another.

FIG. 17 shows a schematic illustration of the illumination device 150. The illumination unit 18 comprises a plurality of luminous elements 20, 22, 24, 26, 28 that are activatable independently of one another. These are configured to emit light according to different emission spectra in order to supply illumination light, i.e. the respective emission spectrum differs from luminous element to luminous element.

By way of example, the luminous elements 20, 22, 24, 26, 28 take the form of LEDs. Specifically, a first luminous element 20 takes the form of a red LED, a second luminous element 22 takes the form of a dark red LED, a third luminous element 24 takes the form of a blue LED, and a fourth luminous element 26 takes the form of a near IR LED. The colored luminous elements 20, 22, 24, 26 each emit in the narrowband, for example with an emission peak approximately at the wavelengths of 660 nm (first luminous element 20), 770 nm (second luminous element 22), 460 nm (third luminous element 24) and 940 nm (fourth luminous element 26).

Furthermore, a fifth luminous element 28 is provided; presently, it is a white-light luminous element, for instance a white-light LED. For example, the fifth luminous element 28 emits in a spectral range from approximately 400 to 700 nm. Laser diodes may also be used in other embodiments, especially as colored luminous elements.

Some of the luminous elements 20, 22, 24, 26, 28 are activated at least intermittently depending on the illumination mode, whereas other luminous elements 20, 22, 24, 26, 28 are optionally not used in the relevant illumination mode.

In the present case, a first group comprises first luminous element 20 and the fourth luminous element 26. The first group may additionally comprise the luminous element 22 and/or the luminous element 24. The first group is used for multispectral imaging, wherein the luminous elements 20, 26 and optionally 22 and 24 contained each serve as a sampling point. For example, in the multispectral mode, illumination is initially implemented using the first luminous element 20, and an image is recorded. Illumination is subsequently implemented using the fourth luminous element 26, and an image is recorded. The images are each based on diffuse reflection, i.e. light scattered back from the object to be imaged is observed. Using the two different sampling points, it is possible to obtain spectral information about the object to be imaged. For example, this can be used to assess specific tissue types, a perfusion state, a tissue characteristic or the like.

Further, a second group comprises the first luminous element 20, the second luminous element 22 and the third luminous element 24. The second group is used for illumination during fluorescence imaging. For example, objects stained with suitably chosen dyes can be observed in a targeted manner in the process. It is also possible to introduce different dyes into different types of tissue or the like, which are observed simultaneously. Targeted excitation of a specific dye causes the latter to fluoresce. Then the fluorescence is imaged. For example, the first luminous element 20 is suitable for exciting the dye cyanine 5.5 (Cy 5.5). The second luminous element 22 is suitable for exciting the dye indocyanine green (ICG). The third luminous element 24 is suitable for exciting the dye fluorescein.

Moreover, a third group comprises the fifth luminous element 28. In the present embodiment, the third group moreover comprises the first luminous element 20 and the third luminous element 24. The third group serves to provide illumination light for white-light imaging. To this end, white light from the fifth luminous element 28 may be mixed with light from specific colored luminous elements, whereby spectral losses may be compensated for and/or a color temperature may be set in a targeted manner.

It is evident that some of the luminous elements 20, 22, 24, 26, 28 are assigned to a plurality of groups; by way of example, the first luminous element 20 is assigned to all three groups and the third luminous element 24 and optionally the second luminous element 22 as well are assigned to the second and the third group.

In an alternative to that or in addition, provision may also be made for some or all of the luminous elements 20, 22, 24, 26, 28 to be used in a hyperspectral mode. A broad excitation spectrum is generated in that case. Then, in combination with a suitable hyperspectral detector, spectral information in relation to the object to be imaged can be captured over the entire visible and near IR spectrum. To this end, the imaging equipment 14 may comprise a pushbroom arrangement as hyperspectral detector. A whiskbroom arrangement, a staring arrangement and/or a snapshot arrangement is used in other embodiments. The imaging equipment 14 may be hyperspectral imaging equipment. As regards different methods of hyperspectral imaging and components required to this end, reference is made to the specialist article “Review of spectral imaging technology in biomedical engineering: achievements and challenges” by Quingli Li et al., published in Journal of Biomedical Optics 18(10), 100901, October 2013, and to the specialist article “Medical hyperspectral imaging: a review” by Guolan Lu and Baowei Fei, published in Journal of Biomedical Optics 19(1), 010901, January 2014.

The illumination unit 18 comprises two crossed beam splitters 30, 32. These each comprise an output side 42, 44, each comprise an input side 37, 41 opposite the output side 42, 44 and each comprise two opposing input sides 34, 36, 38, 40. All input sides 34, 36, 37, 38, 40, 41 guide incident light to the corresponding output side 42, 44. The output side 42 of the first crossed beam splitter 30 faces an input side 41 of the second crossed beam splitter 32. The output side 44 of the second crossed beam splitter 32 faces the optical interface 16. The two crossed beam splitters 30, 32 are by preference arranged coaxial to one another and/or to the optical interface.

The illumination unit 18 may comprise suitable optical elements such as lenses and/or mirrors (not depicted here). By way of example, a plurality of lenses 78, 80, 82, 84, 86, 88 are depicted in FIG. 17. For instance, a lens 78 is assigned to the optical interface 16 and couples light incident from the output side 44 of the second crossed beam splitter 32 into the optical interface 16. Further, a respective lens 80, 82, 84, 86, 88 may be assigned to each of the luminous elements 20, 22, 24, 26, 28. A particularly high degree of compactness can be obtained, especially when the luminous elements 20, 22, 24, 26, 28 are arranged in each case without an interposed mirror on input sides 34, 36, 37, 38, 40 of the at least one crossed beam splitter 30, 32. In that case, the luminous elements 20, 22, 24, 26, 28 may be brought very close to the at least one crossed beam splitter 30, 32.

The crossed beam splitters 30, 32 each comprise two beam splitter elements 90, 92, 94, 96. In principle, these may be partially transmissive such that light from all input sides 34, 36, 37, 38, 40, 41 is deflected to the respective output side 42, 44. In the present embodiment, the beam splitter elements 90, 92, 94, 96 are selectively light transmissive. This is elucidated with further reference to FIG. 3. The beam splitter elements 90, 92, 94, 96 may be filters that only reflect in a defined range but otherwise have a high transmission. FIG. 18 depicts transmission curves 98, 100, 102, 104 of the beam splitter elements 90, 92, 94, 96 of the two crossed beam splitters 30, 32. One of the beam splitter elements 90, 92, 94, 96 is assigned to each of the colored luminous elements 20, 22, 24, 26 or each of the opposite input sides 34, 36, 38, 40. In this case, the beam splitter elements 90, 92, 94, 96 are chosen such that these each reflect in the wavelength range in which the associated luminous element 20, 22, 24, 26 emits but are otherwise largely transmissive. Notch filters, which may by way of example have the transmission spectra 100 and 102, can be used in the mid-wavelength range. High-pass or low-pass filters may also be used instead of notch filters at the spectral edges; cf. transmission spectra 98 and 104.

Light from the fifth luminous element 28 is spectrally curtailed on account of the specific transmission spectra 98, 100, 102, 104 of the crossed beam splitters 30, 32. Thus, in the manner already mentioned above, the light blocked by the beam splitters 30, 32 may expediently be supplemented by means of the luminous elements 20 and 24, optionally also 22 and/or 26, in a targeted manner. As a result, specifically the spectral ranges in which the beam splitters 30, 32 absorb and/or reflect light from the fifth luminous element 28, and in any case do not transmit said light to the optical interface 16, may be supplemented. By preference, the luminous elements 20, 24 and optionally 22 used in addition are operated with reduced power or with adjusted power in this case. At least largely reestablishing the original spectrum of the fifth luminous element 28 may be targeted in the process.

In some embodiments, the fifth luminous element 28 may alternatively be a green luminous element or, expressed in general, a colored luminous element that predominantly emits in the spectral range transmitted by the at least one beam splitter 30, 32. For example, the fifth luminous element 26 of such embodiments may be an LED with an emission peak at approximately 530 nm. A green laser diode also comes into question in this respect. In this case, provision can be made for color mixing in the white-light mode and in particular for use not to be made of an individual white-light source such as a white-light LED but for white light to be mixed in a targeted manner from separate luminous elements.

It is understood that in the case of suitable dyes, such a green luminous element may also be usable in the fluorescence mode. In an alternative to that or in addition, it could be used in the multispectral mode.

The illumination unit 18 defines a common optical path 54, into which light emitted by the luminous elements 20, 22, 24, 26, 28 can be input coupled. The common optical path 54 extends to the optical interface starting from the output side 44 of the second crossed beam splitter 32. In the present case, the common optical path 54 is arranged coaxially with the fifth luminous element 26.

In the embodiment shown, the luminous elements 20, 26 of the first group are arranged such that light emitted by the luminous elements 20, 26 traverses a light path of at least substantially the same length from the respective luminous element 20, 26 to the optical interface 16. The luminous elements 20, 26 of the first group each comprise a light-emitting surface 56, 58. The light-emitting surfaces 56, 62 are arranged equidistantly in relation to the common optical path 54. In the present case, this is achieved by virtue of the two luminous elements 20, 26 being arranged at the same distance from the beam splitter 32 (by way of example, the second beam splitter 32 in the present case) assigned thereto, specifically from the opposite input sides 38, 40 of the latter. In this case, the light is input coupled into the common optical path 54 from the crossed beam splitter 32.

In particular, the beam splitters 30, 32 are arranged in such a way that light-emitting surfaces 56, 58, 60, 62, 64 of the luminous elements 20, 22, 24, 26, 28 are in each case arranged equidistantly in relation to their assigned crossed beam splitter 30, 32.

The illumination unit 18 or the illumination device 12 has a high degree of compactness as a result of using crossed beam splitters 30, 32 and luminous elements 20, 22, 24, 26, 28 that can be used together for different modes. Moreover, the equidistant arrangement may prevent the occurrence of the spectral shifts when the imaging equipment 14 or its light guide is twisted relative to the optical interface 16.

It is understood that a different number of luminous elements 20, 22, 24, 26, 28 and/or a different number of crossed beam splitters 30, 32 can be used. The use of crossed beam splitters 30, 32 was found to be particularly advantageous. However, other types of beam splitters and/or other optical elements may be used in other embodiments in order to input couple light from the luminous elements 20, 22, 24, 26, 28 into the optical interface 16.

### LIST OF REFERENCE SIGNS

110 Endoscope device
112 Lens arrangement
114 Optical axis
116 Eyepiece
118 Objective
120 First plane of symmetry
122 Rod lens
124 Correction element
126 Optical system
128 Lens system
130 First lens
132 Second lens
134 Correction pair arrangement
136 Second plane of symmetry
138 Correction pair arrangement
140 Third plane of symmetry
142 Third lens
144 Aperture
146 Endoscope
148 Imaging system
150 Illumination device
152 Imaging device
154 Image capture unit
156 Display
158 Image capture sensor system
160 Shaft
162 Distal end
164 Proximal end
166 Fourth plane of symmetry
168 Correction pair arrangement
170 Antireflective surface
172 Lens

1-22. (canceled)

23. An endoscope device, comprising a lens arrangement defining an optical axis and configured to optically couple an ocular to an objective, wherein the lens arrangement is designed to provide substantially equivalent transmission and imaging of light for a given focusing over a majority of the visible range as well as in the near-infrared range, wherein the lens arrangement is symmetrical with respect to a first plane of symmetry that is perpendicular to the optical axis, and wherein the lens arrangement comprises:
at least six rod lenses;
at least two correction elements, which together with the rod lenses define an optical system and each define a lens system with at least a first lens and a second lens, wherein the first lens is made of a first glass and the second lens is made of a second glass, wherein the first glass and the second glass have different Abbe numbers, and wherein a relative partial dispersion of the first glass and a relative partial dispersion of the second glass deviate in opposite ways from glass with regular dispersion; and
at least one correction pair arrangement, which comprises two of the correction elements that are symmetrical to each other with respect to a second plane of symmetry that is perpendicular to the optical axis.

24. The endoscope device according to claim 23, wherein the first plane of symmetry and the second plane of symmetry are identical.

25. The endoscope device according to claim 23, wherein the lens arrangement comprises at least one further correction pair arrangement, wherein the further correction pair arrangement comprises two further correction elements which are symmetrical to each other with respect to a third plane of symmetry that is perpendicular to the optical axis.

26. The endoscope device according to claim 25, wherein the second plane of symmetry and the third plane of symmetry are different from the first plane of symmetry.

27. The endoscope device according to claim 23, wherein the correction elements each comprise at least one third lens made of the first glass.

28. The endoscope device according to claim 23, wherein the correction elements are integrally formed with a respective rod lens.

29. The endoscope device according to claim 23, wherein the correction pair arrangement comprises at least one aperture arranged in the region of the second plane of symmetry.

30. The endoscope device according to claim 23, wherein the second lens is a convex lens.

31. The endoscope device according to claim 23, wherein the second lens is a concave lens.

32. The endoscope device according to claim 23, wherein the lens arrangement enables optical imaging in the range of 400 nm to 1000 nm with an RMS spot radius of at most 40 μm.

33. The endoscope device according to claim 23, wherein the lens arrangement enables diffraction-limited optical imaging in the range of 480 nm to 1000 nm.

34. The endoscope device according to claim 23, wherein the lens arrangement comprises a maximum RMS spot radius of at most 8 μm.

35. The endoscope device according to claim 23, wherein the rod lenses and the correction elements comprise anti-reflective surfaces which are effective in the visible range and the near-infrared range.

36. The endoscope device according to claim 35, wherein the anti-reflective surfaces cause an average reflection of at most 2%.

37. The endoscope device according to claim 35, wherein the anti-reflective surfaces cause a maximum reflection of at most 3%.

38. The endoscope device according to claim 23, wherein the lens arrangement in the range of 400 nm to 1000 nm comprises an average transmission of at least 70%.

39. The endoscope device according to claim 23, wherein the lens arrangement in the range of 400 nm to 1000 nm comprises a minimum transmission of at least 60%.

40. The endoscope device according to claim 23, further comprising the ocular and/or the objective.

41. A correction pair arrangement for a lens arrangement of an endoscope, comprising at least two correction elements defining an optical axis and configured to define an optical system together with several rod lenses and each correction element comprises a lens system with at least a first lens and a second lens, wherein the first lens is made of a first glass and the second lens is made of a second glass, wherein the first glass and the second glass have different Abbe numbers, and wherein a relative partial dispersion of the first glass and the second glass deviate in opposite ways from glass with normal dispersion;
wherein the correction elements are symmetrical to each other with respect to a plane of symmetry that is perpendicular to the optical axis.

42. An imaging system, comprising
an illumination device configured to provide illumination light in both the visible range and the near-infrared range;
an endoscope device, comprising a lens arrangement defining an optical axis and configured to optically couple an ocular to an objective, wherein the lens arrangement is designed to provide substantially equivalent transmission and imaging of light for a given focusing over a majority of the visible range as well as in the near-infrared range, wherein the lens arrangement is symmetrical with respect to a first plane of symmetry that is perpendicular to the optical axis, and wherein the lens arrangement comprises:
at least six rod lenses; at least two correction elements, which together with the rod lenses define an optical system and each define a lens system with at least a first lens and a second lens, wherein the first lens is made of a first glass and the second lens is made of a second glass, wherein the first glass and the second glass are having different Abbe numbers, and wherein a relative partial dispersion of the first glass and a relative partial dispersion of the second glass deviate in opposite ways from glass with regular dispersion; and at least one correction pair arrangement, which comprises two of the correction elements that are symmetrical to each other with respect to a second plane of symmetry that is perpendicular to the optical axis; and
an imaging device comprising an image capturing unit configured to capture multispectral and/or hyperspectral image data.
